(19) United States
(12) Patent Application Publication
(10) Pub. No.: US 2026/0229734 A1
(43) Pub. Date: Aug. 6, 2026

(54) INTEGRATED BATTERY SENSING AND THERMAL BARRIER ASSEMBLIES FOR TRACTION BATTERY ARRAYS

(71) Applicant: FORD GLOBAL TECHNOLOGIES, LLC, Dearborn, MI (US)

(72) Inventors: John Marshall Penney, Livonia, MI (US); Liam Faecke, Detroit, MI (US); Shaurya Sarna, Novi, MI (US); Douglas Christian Lipp, Ann Arbor, MI (US)

(21) Appl. No.: 19/045,706

(22) Filed: Feb. 5, 2025

(51) Int. Cl. H01M 50/569; H01M 10/658; H01M 50/211; H01M 50/249; H01M 50/342; H01M 50/519

(52) U.S. Cl. CPC H01M 50/569; H01M 10/658; H01M 50/211; H01M 50/249; H01M 50/3425; H01M 50/519; H01M 2220/20

(57) ABSTRACT

Integrated battery sensing and thermal barrier assemblies are provided for battery arrays of a traction battery pack. An exemplary integrated battery sensing and thermal barrier assembly may combine the functions of both a thermal barrier and a flexible printed circuit assembly into a single part. The integrated battery sensing and thermal barrier assembly is thus configured to both mitigate the transfer of thermal energy between the battery array and adjacent structures and monitor battery cell operating parameters.

### TECHNICAL FIELD

This disclosure relates generally to traction battery packs, and more particularly to integrated battery sensing and thermal barrier assemblies for use with traction battery arrays.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a plurality of battery cells arranged to extend between a first cross-member assembly and a second cross-member assembly. The first cross-member assembly and the second cross-member assembly each include a ladder frame and an integrated battery sensing and thermal barrier assembly mounted to the ladder frame. The integrated battery sensing and thermal barrier assembly includes a thermally insulating sheet and a flexible printed circuit assembly.

In a further non-limiting embodiment of the foregoing traction battery pack, the plurality of battery cells includes pouch battery cells.

In a further non-limiting embodiment of either of the foregoing traction battery packs, the ladder frame includes a plurality of cell tab openings each sized to receive a tab terminal of one or more of the plurality of battery cells.

In a further non-limiting embodiment of any of the foregoing traction battery packs, the tab terminal is joined to a bus bar by a bus bar retainer.

In a further non-limiting embodiment of any of the foregoing traction battery packs, a sense lead of the integrated battery sensing and thermal barrier assembly is joined to the bus bar.

In a further non-limiting embodiment of any of the foregoing traction battery packs, the ladder frame includes a stake received through a mounting hole of the integrated battery sensing and thermal barrier assembly.

In a further non-limiting embodiment of any of the foregoing traction battery packs, an adhesive strip secures the integrated battery sensing and thermal barrier assembly to the ladder frame.

In a further non-limiting embodiment of any of the foregoing traction battery packs, the thermally insulating sheet is a flexible mica sheet.

In a further non-limiting embodiment of any of the foregoing traction battery packs, the flexible printed circuit assembly includes a plurality of conductive traces sandwiched between a first pressure sensitive adhesive and a second pressure sensitive adhesive.

In a further non-limiting embodiment of any of the foregoing traction battery packs, a connector end of the integrated battery sensing and thermal barrier assembly is operably connected to a sensing unit.

In a further non-limiting embodiment of any of the foregoing traction battery packs, the thermally insulating sheet and the flexible printed circuit assembly together establish a multi-layered laminate structure of the integrated battery sensing and thermal barrier assembly.

In a further non-limiting embodiment of any of the foregoing traction battery packs, the multi-layered laminate structure includes a weakened area that can selectively open to provide a pathway for allowing a battery cell vent product to pass through the integrated battery sensing and thermal barrier assembly during a battery thermal event.

In a further non-limiting embodiment of any of the foregoing traction battery packs, a thermal resistant tape is applied to the flexible printed circuit assembly.

A traction battery pack according to another exemplary aspect of the present disclosure includes, among other things, an integrated battery sensing and thermal barrier assembly including a thermally insulating sheet and a flexible printed circuit assembly that together establish a multi-layered laminate structure of the integrated battery sensing and thermal barrier assembly.

In a further non-limiting embodiment of the foregoing traction battery pack, the integrated battery sensing and thermal barrier assembly is mounted to a ladder frame of a battery array.

In a further non-limiting embodiment of either of the foregoing traction battery packs, the thermally insulating sheet is a flexible mica sheet.

In a further non-limiting embodiment of any of the foregoing traction battery packs, the flexible printed circuit assembly includes a plurality of conductive traces sandwiched between a first pressure sensitive adhesive and a second pressure sensitive adhesive.

In a further non-limiting embodiment of any of the foregoing traction battery packs, a sense lead is mounted within a window of the multi-layered laminate structure.

In a further non-limiting embodiment of any of the foregoing traction battery packs, a thermal resistant tape is applied over the window.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates select portions of an exemplary battery array of a traction battery pack.

FIG. 4 is an exploded view of select portions of the battery array of FIG. 3.

FIG. 5 illustrates a first side of an integrated battery sensing and thermal barrier assembly.

FIG. 6 illustrates a second side of the integrated battery sensing and thermal barrier assembly of FIG. 5.

FIG. 7 is a cross-sectional view of an integrated battery sensing and thermal barrier assembly.

### DETAILED DESCRIPTION

This disclosure details integrated battery sensing and thermal barrier assemblies for battery arrays of a traction battery pack. An exemplary integrated battery sensing and thermal barrier assembly may combine the functions of both a thermal barrier and a flexible printed circuit assembly into a single part. The integrated battery sensing and thermal barrier assembly is thus configured to both mitigate the transfer of thermal energy between the battery array and adjacent structures and monitor battery cell operating parameters. These and other features are discussed in greater detail in the following paragraphs of this detailed description.

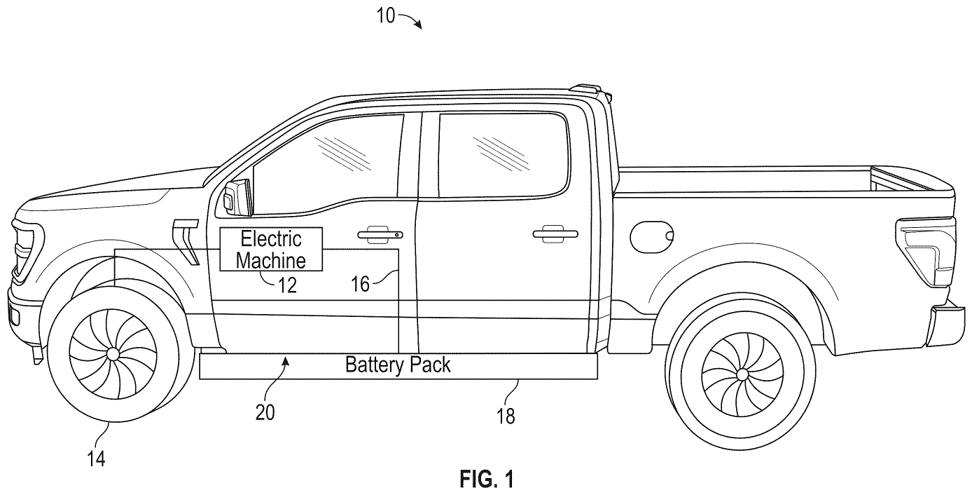

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

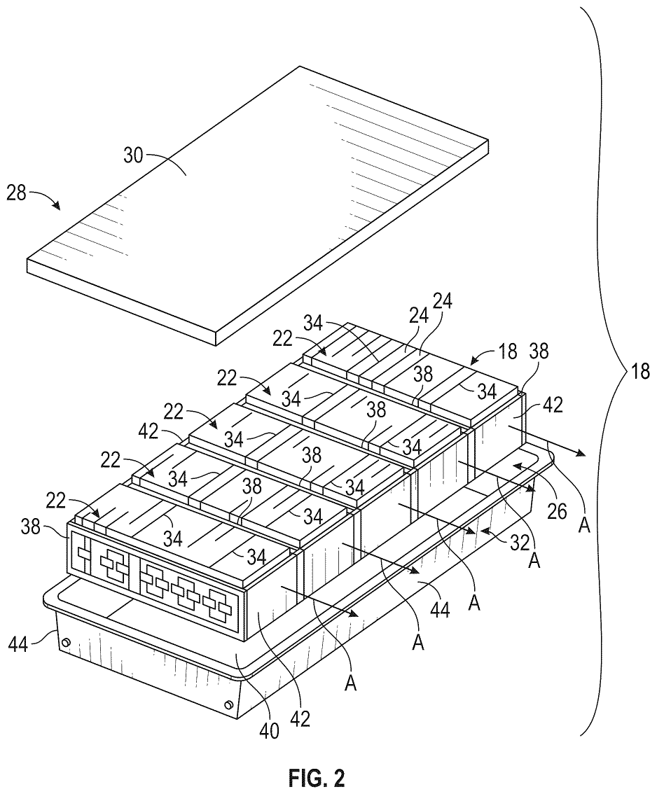

FIG. 2 illustrates additional details associated with the traction battery pack 18 of the electrified vehicle 10 of FIG. 1. The traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 2.

In an embodiment, the battery cells 24 are lithium-ion pouch cells. However, battery cells having other geometries and/or chemistries (nickel-metal hydride, lead-acid, etc.) could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 of the traction battery pack 18 may include an enclosure cover 30 and an enclosure tray 32. The enclosure cover 30 may be secured (e.g., bolted, welded, adhered, etc.) to the enclosure tray 32 to provide the interior area 26 for housing the battery arrays 22 and other battery internal components of the traction battery pack 18.

The battery cells 24 of each battery array 22 may be stacked together and arranged along a stack axis A. One or more thermal barrier assemblies 34 may be arranged along the respective stack axis A of each battery array 22. The thermal barrier assemblies 34 may compartmentalize each battery array 22 into two or more groupings or compartments. Each compartment may hold one or more of the battery cells 24 of the battery array 22.

The battery cells 24 of each battery array 22 may be arranged to laterally extend between a pair of cross-member assemblies 38. Among other functions, the cross-member assemblies 38 may be configured to electrically connect the battery cells 24 within each battery array 22 and at least partially delineate the battery arrays 22 from one another within the interior area 26 of the enclosure assembly 28.

A vertically lower side of each battery array 22 may interface with a heat exchanger plate 40 that is positioned against a floor of the enclosure tray 32. However, in another embodiment, the heat exchanger plate 40 could be omitted and the vertically lower side of each battery array 22 may be received in direct contact with the floor of the enclosure tray 32. Vertical and horizontal, for purposes of this disclosure, are with reference to ground and a general orientation of traction battery pack 18 when installed on the electrified vehicle 10 of FIG. 1.

Each battery array 22 may be arranged to extend along its respective stack axis A between opposing end plates 42. The end plates 42 may be positioned between the ends of the battery arrays 22 and longitudinally extending side walls 44 of the enclosure tray 32. The end plates 42 may therefore extend along axes that are substantially transverse (e.g., perpendicular) to the stack axes A of the battery arrays 22.

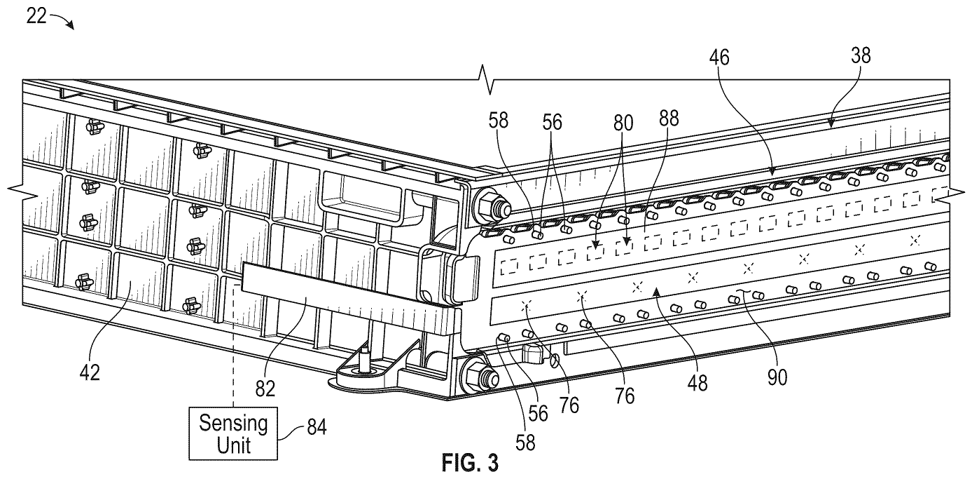

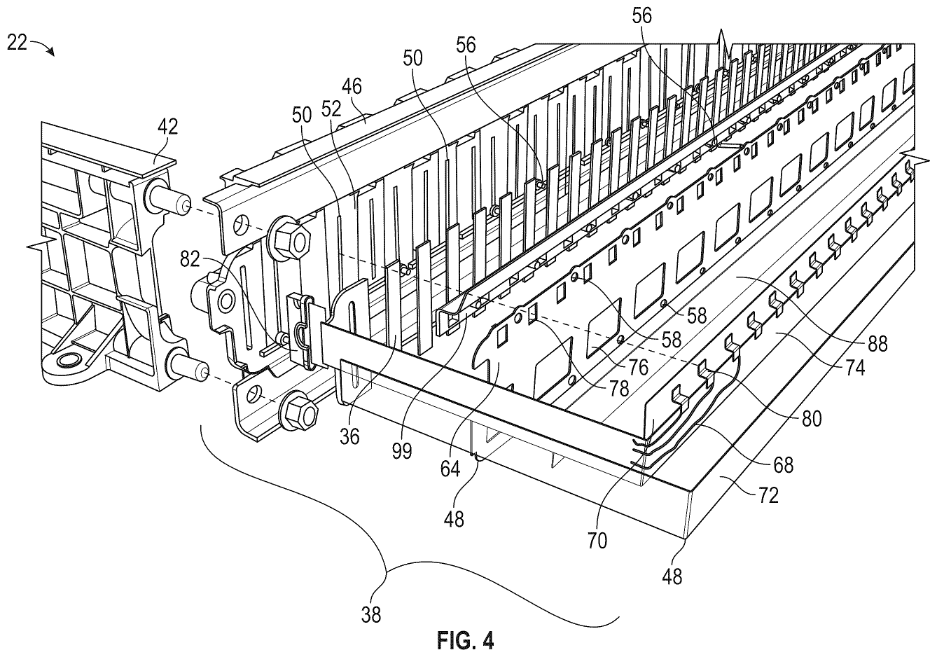

FIGS. 3 and 4 illustrate one of the battery arrays 22 of the traction battery pack of FIGS. 1-2. Additional battery arrays of the traction battery pack could have a similar design to the battery array 22 shown in FIGS. 3-4.

Each cross-member assembly 38 of the battery array 22 may include a ladder frame 46 and an integrated battery sensing and thermal barrier assembly 48 that is securable to the ladder frame 46. The ladder frame 46 may be either a unitary or a multi-piece injection molded structure and may be made of any suitable thermoplastic material.

The ladder frame 46 may include a plurality of cell tab openings 50 (best shown in FIG. 4). The cell tab openings 50 may be elongated slots formed through the ladder frame 46. A column 52 of the ladder frame 46 may vertically extend between adjacent cell tab openings 50. The total numbers of cell tab openings 50 and columns 52 provided within the ladder frame 46 can vary and is therefore not intended to limit this disclosure.

Each cell tab opening 50 may be configured to accommodate one or more cell tab terminals (not shown) of one or more battery cells 24 of the battery array 22. Each cell tab terminal may protrude outwardly from a housing of one of the battery cells 24. In an embodiment, each battery cell 24 includes a pair of cell tab terminals, with one of the cell tab terminals projecting from a first side of the housing and providing a positive terminal of the battery cell 24, and the other cell tab terminal projecting from an opposite side of the housing and providing a negative terminal of the battery cell 24. The positive terminals can be electrically connected by bus bars 36 located at a first side of the battery array 22, and the negative terminals can be electrically connected by additional bus bars located on a second, opposite side of the battery array 22. However, other configurations are further contemplated within the scope of this disclosure.

The bus bars 36 may be metallic components. In an embodiment, the bus bars 36 are made of copper or aluminum. However, other materials or combinations of materials are contemplated within the scope of this disclosure. The bus bars 36 may be joined (e.g., welded) to the tab terminals for electrically connecting the battery cells 24 of the battery array 22.

The bus bars 36 may be retained to the ladder frame 46 by a bus bar retainer 99 (see FIG. 4). The bus bar retainer 99 may be an elongated header-like structure located between the bus bars 36 and the integrated battery sensing and thermal barrier assembly 48.

The integrated battery sensing and thermal barrier assembly 48 may be secured to the ladder frame 46. As further discussed below, the integrated battery sensing and thermal barrier assembly 48 may be a multi-functional part that is configured to integrate the functionally of both a flexible printed circuit and a thermal barrier within a single component of the battery array 22.

In an embodiment, the ladder frame 46 may include stakes 56 that can be received through mounting holes 58 of the integrated battery sensing and thermal barrier assembly 48. The heads of the stakes 56 may subsequently be deformed, such as via heat staking or cold working, for example, to mount the integrated battery sensing and thermal barrier assembly 48 to the ladder frame 46.

Alternatively or additionally, one or more adhesive strips 60 (see FIG. 6) may be secured to a backside 62 of the integrated battery sensing and thermal barrier assembly 48. The backside 62 faces toward the ladder frame 46. The adhesive strips 60 may secure the integrated battery sensing and thermal barrier assembly 48 to the ladder frame 46. The adhesive strips 60 may also establish a sealed interface between the ladder frame 46 and the integrated battery sensing and thermal barrier assembly 48.

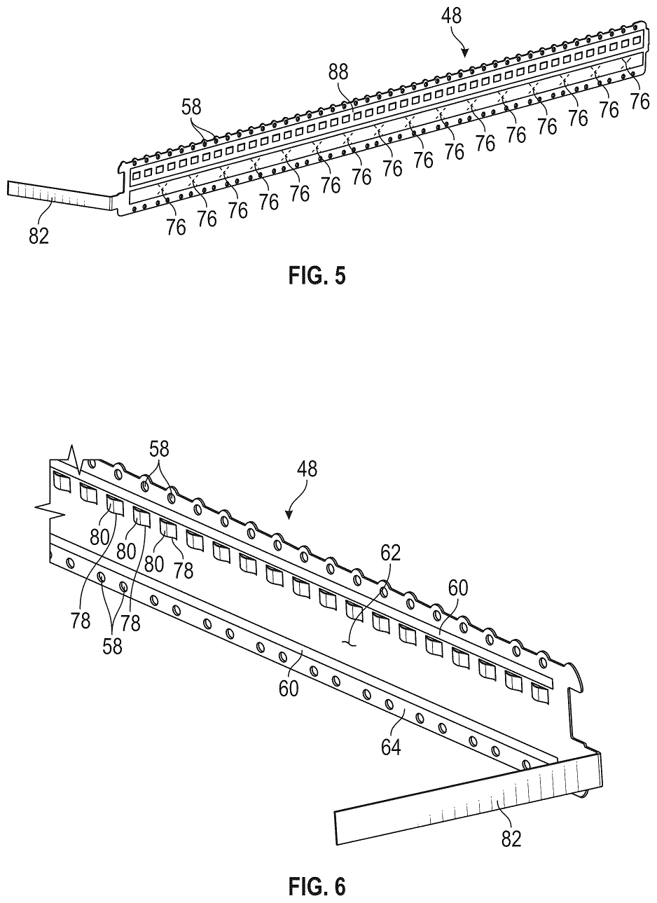

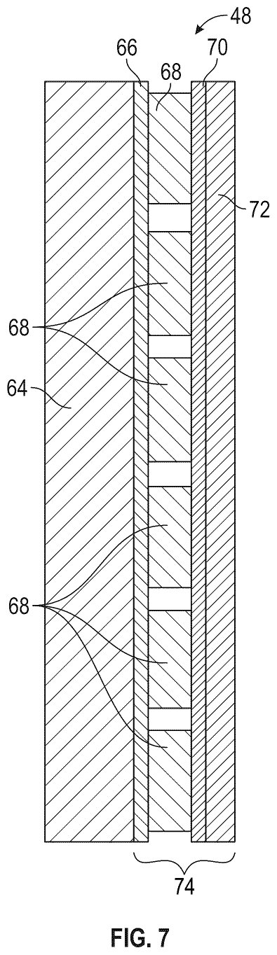

Referring now to FIGS. 5, 6, and 7, with continued reference to FIGS. 3-4, the integrated battery sensing and thermal barrier assembly 48 may include a multi-layered laminate structure that is designed to provide multiple functions. For example, the integrated battery sensing and thermal barrier assembly 48 may function to both monitor and communicate data (e.g., temperature, voltage, current, state of charge, etc.) associated with the battery cells 24 of the battery array 22 and to mitigate the transfer of thermal energy between the battery array 22 and neighboring structures.

The multi-layered laminate structure of the integrated battery sensing and thermal barrier assembly 48 may include a thermally insulating sheet 64, a first pressure sensitive adhesive 66, a plurality of conductive traces 68, a second pressure sensitive adhesive 70, and a dielectric film 72. The first pressure sensitive adhesive 66 may border the thermally insulating sheet 64, the conductive traces 68 may be sandwiched between the first pressure sensitive adhesive 66 and the second pressure sensitive adhesive 70, and the dielectric film 72 may be applied over the second pressure sensitive adhesive 70.

The first pressure sensitive adhesive 66, the plurality of conductive traces 68, the second pressure sensitive adhesive 70, and the dielectric film 72 may cooperate to establish a flexible printed circuit assembly 74 of the integrated battery sensing and thermal barrier assembly 48. The thermally insulating sheet 64 and the flexible printed circuit assembly 74 together provide the integrated battery sensing and thermal barrier assembly 48.

The thermally insulating sheet 64 may be made of a flame resistant and heat insulating material. In an embodiment, the thermally insulating sheet 64 is a flexible mica sheet. However, the thermally insulating sheet 64 could be made of aerogel materials, refractory ceramic fibers, or other materials or combinations of materials that are capable of providing flame resistant and heat insulation properties.

The thermally insulating sheet 64 may limit the transfer of thermal energy between the battery array 22 and a neighboring structure, such as another battery array, for example, during both normal operating conditions and during a battery thermal event. During a battery thermal event, temperature and pressure within one or more of the battery cells 24 can increase and cause the battery cell 24 to release battery cell vent byproducts V. The thermally insulating sheet 64 can mitigate or even prevent thermal energy associated with the battery cell vent byproducts V from thermally influencing an adjacent battery array or other battery internal structure of the traction battery pack 18.

The multi-layered laminate structure of the integrated battery sensing and thermal barrier assembly 48 may be further configured to provide pathways that permit the battery cell vent byproducts V to move outward away from the battery array 22 to keep the battery cell vent byproducts V away from battery cells 24 that are not venting, thereby preventing propagation of the thermal energy across the battery array 22. To this end, the multi-layered laminate structure of the integrated battery sensing and thermal barrier assembly 48 may include a plurality of weakened areas 76 that can each be selectively opened to provide the pathway for allowing the battery cell vent products V to escape the battery array 22. The weakened areas 76 may melt, rupture, or otherwise deform to allow the battery cell vent byproducts V to escape through the integrated battery sensing and thermal barrier assembly 48 during the battery thermal event.

A plurality of windows 78 (best shown in FIG. 6) may be formed through the multi-layered laminate structure of the integrated battery sensing and thermal barrier assembly 48. The windows 78 may be provided at a location that aligns to the bus bars 36 of the battery array 22. A sense lead 80 may be mounted within each window 78.

Each sense lead 80 may be joined to one of the bus bars 36 and may be configured to collect data (e.g., temperature, voltage, current, state of charge, etc.) associated with the battery cells 24 of the battery array 22 as part of a battery management system of the traction battery pack 18. In an embodiment, the sense leads 80 may be secured to the bus bars 36 by one or more welds (e.g., laser welds).

A thermal barrier tape 88 may be applied over the windows 78 after joining the sense leads 80 to the bus bars 36. The thermal barrier tape 88 may seal the openings formed by the windows 78. The thermal barrier tape 88 may be applied to an exterior side 90 of the multi-layered laminate structure of the integrated battery sensing and thermal barrier assembly 48. The exterior side 90 is located on an opposite side from the backside 62 and thus faces in a direction away from the ladder frame 46.

The sense leads 80 may be operably connected to the conductive traces 68 of the flexible printed circuit assembly 74. The data collected by the sense leads 80 may be fed to a connector end 82 of the flexible printed circuit assembly 74 via the conductive traces 68. The connector end 82, which may also include the multi-layered laminate structure, may be mounted to one of the end plates 42 of the battery array 22 and may be operably connected to a sensing unit 84, such as a battery pack sensing module, for example. The sensing unit 84 may periodically communicate data to a controller associated with the battery management system as part of control strategy for controlling charging and discharging operations of the traction battery pack 18.

The exemplary integrated battery sensing and thermal barrier assemblies of this disclosure integrate the functions of both thermal barriers and flexible printed circuit assemblies into a single part. Prior battery array systems required the use of separate thermal barriers and flexible printed circuit assemblies. The proposed systems therefore provide a more efficient packaging design that simplifies battery array assembly.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a plurality of battery cells arranged to extend between a first cross-member assembly and a second cross-member assembly; and
the first cross-member assembly and the second cross-member assembly each including a ladder frame and an integrated battery sensing and thermal barrier assembly mounted to the ladder frame,
wherein the integrated battery sensing and thermal barrier assembly includes a thermally insulating sheet and a flexible printed circuit assembly.

2. The traction battery pack as recited in claim 1, wherein the plurality of battery cells includes pouch battery cells.

3. The traction battery pack as recited in claim 1, wherein the ladder frame includes a plurality of cell tab openings each sized to receive a tab terminal of one or more of the plurality of battery cells.

4. The traction battery pack as recited in claim 3, wherein the tab terminal is joined to a bus bar.

5. The traction battery pack as recited in claim 4, wherein the bus bar is joined to the ladder frame by a bus bar retainer.

6. The traction battery pack as recited in claim 5, wherein a sense lead of the integrated battery sensing and thermal barrier assembly is joined to the bus bar.

7. The traction battery pack as recited in claim 1, wherein the ladder frame includes a stake received through a mounting hole of the integrated battery sensing and thermal barrier assembly.

8. The traction battery pack as recited in claim 1, comprising an adhesive strip that secures the integrated battery sensing and thermal barrier assembly to the ladder frame.

9. The traction battery pack as recited in claim 1, wherein the thermally insulating sheet is a flexible mica sheet.

10. The traction battery pack as recited in claim 1, wherein the flexible printed circuit assembly includes a plurality of conductive traces sandwiched between a first pressure sensitive adhesive and a second pressure sensitive adhesive.

11. The traction battery pack as recited in claim 1, wherein a connector end of the integrated battery sensing and thermal barrier assembly is operably connected to a sensing unit.

12. The traction battery pack as recited in claim 1, wherein the thermally insulating sheet and the flexible printed circuit assembly together establish a multi-layered laminate structure of the integrated battery sensing and thermal barrier assembly.

13. The traction battery pack as recited in claim 12, wherein the multi-layered laminate structure includes a weakened area that can selectively open to provide a pathway for allowing a battery cell vent product to pass through the integrated battery sensing and thermal barrier assembly during a battery thermal event.

14. The traction battery pack as recited in claim 1, comprising a thermal resistant tape applied to the flexible printed circuit assembly.

15. A traction battery pack, comprising:
an integrated battery sensing and thermal barrier assembly including:
a thermally insulating sheet and a flexible printed circuit assembly that together establish a multi-layered laminate structure of the integrated battery sensing and thermal barrier assembly.

16. The traction battery pack as recited in claim 15, wherein the integrated battery sensing and thermal barrier assembly is mounted to a ladder frame of a battery array.

17. The traction battery pack as recited in claim 15, wherein the thermally insulating sheet is a flexible mica sheet.

18. The traction battery pack as recited in claim 15, wherein the flexible printed circuit assembly includes a plurality of conductive traces sandwiched between a first pressure sensitive adhesive and a second pressure sensitive adhesive.

19. The traction battery pack as recited in claim 15, comprising a sense lead mounted within a window of the multi-layered laminate structure.

20. The traction battery pack as recited in claim 19, comprising a thermal resistant tape applied over the window.
